(19) United States
(12) Patent Application Publication
(10) Pub. No.: US 2025/0211329 A1
(43) Pub. Date: Jun. 26, 2025

(54) APPARATUS AND METHOD FOR REAL-TIME MONITORING DELAY SKEW OF SUBSIGNAL OF OPTICAL TRANSMITTER

(71) Applicant: Fujitsu Limited, Kawasaki-shi (JP)

(72) Inventors: Tong YE, Beijing (CN); Zhenning TAO, Beijing (CN); Xiaofei SU, Beijing (CN)

(73) Assignee: Fujitsu Limited, Kawasaki-shi (JP)

(21) Appl. No.: 18/980,251

(22) Filed: Dec. 13, 2024

(30) Foreign Application Priority Data
Dec. 22, 2023 (CN) 202311787551.2

(51) Int. Cl. H04B 10/079

(52) U.S. Cl. CPC H04B 10/0795; H04B 10/0799

(57) ABSTRACT

An apparatus and a method for real-time monitoring delay skew of a sub-signal of an optical transmitter may include inputting a first input signal to a first electro-optical conversion unit, modulating to-be-modulated light to obtain a first output signal; inputting a second input signal to a second electro-optical conversion unit, modulating to-be-modulated light to obtain a second output signal, the second input signal is a differential signal of the first input signal; performing correlation operation processing on the first output signal and the second output signal to obtain correlation of the first input signal and the second input signal; and determining delay skew between an output signal of the first electro-optical conversion unit and an output signal of the second electro-optical conversion unit according to the correlation and a pre-set corresponding relation between a correlation and the delay skew. Hence, delay skew between two high-speed signals may be monitored by only using a low-bandwidth electrical device without using a high-speed equipment.

### CROSS REFERENCE TO RELATED APPLICATIONS

This application claims priority under 35 USC 119 to Chinese patent application no. 202311787551.2, filed on Dec. 22 2023, in the China National Intellectual Property Administration, the entire contents of which are incorporated herein by reference.

### TECHNICAL FIELD

Embodiments of the present disclosure relate to the field of optical communication technology.

### BACKGROUND

In the field of optical communication, in order to achieve a greater communication capacity, a signal rate output by a transmitter is very high, such as 100G bauds. These signals typically include a plurality of sub-signals. For example, a dual-polarization system has two polarization components, i.e., x and y; a coherence system has an in-phase component I and a quadrature component Q; under a DAC architecture, PAM8 is a superposition of three 0/1 sequences, and each 0/1 sequence constitutes a sub-signal. Under modulation by a multi-modulation unit (multi-segment), a total signal is a superposition of signals of each modulation unit (segment), and a sub-signal is formed on each modulation unit. In terms of hardware implementation, these sub-signals are typically generated by different electrical and optical components, so different sub-signals may have different analog characteristics, for example, there are different delay skew between different sub-signals. Such delay skew leads to distortion of an output signal, thereby causing degradation of system performance. Currently, delays of all sub-signals are calibrated before a transmitter is used, so as to reduce an impact brought by delay skew. However, even if the delays of all sub-signals are calibrated before the transmitter is used, a change in temperature and environment, etc. may still cause a delay between sub-signals to deviate again. Therefore, it is very necessary to monitor delay skew of a sub-signal in real-time without affecting normal communication.

It should be noted that the above introduction to the technical background is just to facilitate a clear and complete description of the technical solutions of the present disclosure, and is elaborated to facilitate the understanding of persons skilled in the art, it cannot be considered that these technical solutions are known by persons skilled in the art just because these solutions are elaborated in the Background of the present disclosure.

### SUMMARY

However, the inventor finds that for a high-speed optical transmitter with a plurality of sub-signals, a scheme of adjusting delay skew of each sub-signal may monitor eye diagram quality at output end of the transmitter, then adjust delay skew of the sub-signals on its transmitting end AWG based on the eye diagram quality. However, this scheme needs an expensive real-time signal analysis equipment to obtain output waveforms at a receiving end, which is difficult to achieve in application, and this scheme cannot monitor delay skew without affecting normal communication.

For at least one of the above technical problems, the embodiments of the present disclosure provide an apparatus and a method for real-time monitoring delay skew of a sub-signal of an optical transmitter. Using correlation of a high-speed sub-signal and another high-speed signal in a communication process of an optical transmitter to indicate delay of the optical transmitter or an electro-optical conversion unit of the optical transmitter, implementation is simple, an implementation mode is flexible, and a use range is wide.

According to one aspect of the embodiments of the present disclosure, an apparatus for real-time monitoring delay skew of a sub-signal of an optical transmitter is provided, the apparatus including a memory and a processor coupled to the memory to: input a first input signal to a first electro-optical conversion unit, to enable the first electro-optical conversion unit to modulate to-be-modulated light according to the first input signal and to obtain a first output signal; input a second input signal to a second electro-optical conversion unit, to enable the second electro-optical conversion unit to modulate to-be-modulated light according to the second input signal and to obtain a second output signal, wherein the second input signal is a differential signal of the first input signal; perform correlation operation processing on the first output signal and the second output signal to obtain correlation of the first input signal and the second input signal; determine delay skew between an output signal of the first electro-optical conversion unit and an output signal of the second electro-optical conversion unit according to the correlation and a pre-set corresponding relation between correlation and the delay skew.

According to one aspect of the embodiments of the present disclosure, a method for real-time monitoring delay skew of a sub-signal of an optical transmitter is provided, the method including: inputting a first input signal to a first electro-optical conversion unit, to enable the first electro-optical conversion unit to modulate to-be-modulated light according to the first input signal and to obtain a first output signal; inputting a second input signal to a second electro-optical conversion unit, to enable the second electro-optical conversion unit to modulate to-be-modulated light according to the second input signal and to obtain a second output signal; wherein the second input signal is a differential signal of the first input signal; performing correlation operation processing on the first output signal and the second output signal to obtain correlation of the first input signal and the second input signal; and determining delay skew between an output signal of the first electro-optical conversion unit and an output signal of the second electro-optical conversion unit according to the correlation and a pre-set corresponding relation between correlation and the delay skew.

One of advantageous effects of the embodiments of the present disclosure includes: in the present disclosure, delay skew is determined using a signal output by an electro-optical conversion unit of an optical transmitter, real-time monitoring of the delay skew is implemented, and there is no need for the optical transmitter to transmit a special signal; moreover, in the present disclosure, sub-signal delay skew monitoring of the optical transmitter may be implemented by using a low-bandwidth electrical device, which avoids use of a high-speed equipment, and may be flexibly implemented via an integrated or non-integrated mode; in addition, application scenarios of the present disclosure are rich, and are suitable for sub-signal delay skew monitoring in a variety of optical transmitters.

Referring to the later description and drawings, specific implementations of the embodiments of the present disclosure are disclosed in detail, indicating a manner that the principle of the embodiments of the present disclosure can be adopted. It should be understood that the implementations of the present disclosure are not limited in terms of a scope. Within the scope of the spirit and terms of the attached claims, the implementations of the present disclosure include many changes, modifications and equivalents.

### BRIEF DESCRIPTION OF DRAWINGS

The included drawings are used to provide a further understanding on the embodiments of the present disclosure, constitute a part of the Specification, are used to illustrate the implementations of the present disclosure, and expound the principle of the present disclosure together with the text description. Obviously, the drawings in the following description are only some embodiments of the present disclosure. Persons skilled in the art can further obtain other implementations based on the drawings under the premise that they do not pay inventive labor. In the drawings:

FIG. 1 is a schematic diagram of a method for real-time monitoring of a sub-signal delay skew of an optical transmitter in the embodiments of the present disclosure;

FIG. 2A to FIG. 2D are schematic diagrams of a first electro-optical conversion unit in the embodiments of the present disclosure;

FIG. 3 is a schematic diagram in which a second input signal operates at intervals in the embodiments of the present disclosure;

FIG. 4A to FIG. 4E are schematic diagrams of a second electro-optical conversion unit in the embodiments of the present disclosure;

FIG. 5A to FIG. 5B are schematic diagrams of a photoelectric multiplier or a photoelectric conversion unit in the embodiments of the present disclosure;

FIG. 6A to FIG. 6B are schematic diagrams of an electrical average unit in the embodiments of the present disclosure;

FIG. 7 to FIG. 10 are schematic diagrams of a hardware structure for determining a correlation in the embodiments of the present disclosure;

FIG. 11A to FIG. 11C are schematic diagrams of a corresponding relation between a correlation and delay skew in the embodiments of the present disclosure;

FIG. 12 is a schematic diagram of an apparatus for real-time monitoring delay skew of a sub-signal of an optical transmitter in the embodiments of the present disclosure; and

FIG. 13 is a schematic diagram of an electronic device in the embodiments of the present disclosure.

### DETAILED DESCRIPTION

Referring to the drawings, through the following Specification, the above and other features of the embodiments of the present disclosure will become obvious. The Specification and the figures specifically disclose particular implementations of the present disclosure, showing partial implementations which can adopt the principle of the embodiments of the present disclosure. It should be understood that the present disclosure is not limited to the described implementations, on the contrary, the embodiments of the present disclosure include all the modifications, variations and equivalents falling within the scope of the attached claims.

In the embodiments of the present disclosure, the term “first” and “second”, etc. are used to distinguish different elements in terms of appellation, but do not represent a spatial arrangement or time sequence, etc. of these elements, and these elements should not be limited by these terms. The term “and/or” includes any and all combinations of one or more of the associated listed terms. The terms “include”, “comprise” and “have”, etc. refer to the presence of stated features, elements, members or components, but do not preclude the presence or addition of one or more other features, elements, members or components.

In the embodiments of the present disclosure, the singular forms “a/an” and “the”, etc. include plural forms, and should be understood broadly as “a kind of” or “a type of”, but are not defined as the meaning of “one”; in addition, the term “the” should be understood to include both the singular forms and the plural forms, unless the context clearly indicates otherwise. In addition, the term “according to” should be understood as “at least partially according to . . . ”, the term “based on” should be understood as “at least partially based on . . . ”, unless the context clearly indicates otherwise.

Features that are described and/or illustrated with respect to one implementation may be used in the same way or in a similar way in one or more other implementations and in combination with or instead of the features in the other implementations. The term “comprise/include” when being used herein refers to the presence of a feature, a whole piece, a step or a component, but does not exclude the presence or addition of one or more other features, whole pieces, steps or components.

### Embodiments of a First Aspect

Embodiments of the present disclosure provide a method for real-time monitoring delay skew of a sub-signal of an optical transmitter. FIG. 1 is a schematic diagram of a method for real-time monitoring delay skew of a sub-signal of an optical transmitter in the embodiments of the present disclosure. As shown in FIG. 1, the method includes:
101, a first input signal is input to a first electro-optical conversion unit, to enable the first electro-optical conversion unit to modulate to-be-modulated light according to the first input signal and to obtain a first output signal;
102, a second input signal is input to a second electro-optical conversion unit, to enable the second electro-optical conversion unit to modulate to-be-modulated light according to the second input signal and to obtain a second output signal; wherein the second input signal is a differential signal of the first input signal;
103, correlation operation processing is performed on the first output signal and the second output signal to obtain correlation of the first input signal and the second input signal; and
104, delay skew between an output signal of the first electro-optical conversion unit and an output signal of the second electro-optical conversion unit is determined according to the correlation and a pre-set corresponding relation between correlation and the delay skew.

It should be noted that the above FIG. 1 only schematically describes the embodiments of the present disclosure, but the present disclosure is not limited to this. For example, some of the above steps may be performed simultaneously or in a sequential order, an execution step of each operation may be adjusted appropriately, moreover other some operations may be increased or reduced. Persons skilled in the art may make appropriate modifications according to the above contents, not limited to the records in the above FIG. 1.

In the operation 101, a first input signal is input to a first electro-optical conversion unit, to enable the first electro-optical conversion unit to modulate to-be-modulated light according to the first input signal and to obtain a first output signal.

In some embodiments, the first input signal may be any signal, and it is denoted as a first input signal A[n] in the present disclosure. The first input signal A[n] may be a discrete symbol sequence or a continuous signal, where, n denotes a time sequence number. The first electro-optical conversion unit modulates to-be-modulated light input thereto according to the first input signal A[n], to obtain a first output signal, the first output signal is a high-speed signal and an optical signal. The to-be-modulated light e.g., is direct current light, or an optical signal output by an upper level unit connected to the first electro-optical conversion unit.

In some embodiments, the first electro-optical conversion unit is a unit with a modulation function and being capable of generating a high-speed signal. For example, the first electro-optical conversion unit is an optical transmitter per se, in this case, the first output signal is a total output optical signal of the optical transmitter. The first electro-optical conversion unit may further be a partial modulation unit of the optical transmitter, in this case, the first output signal is a part of the total output optical signal of the optical transmitter, that is, the first output signal is included in the total output optical signal of the optical transmitter. The optical transmitter includes but is not limited to a coherent transmitter, an intensity modulation transmitter, a phase modulator, a combination signal transmitter based on an optical frequency comb, etc.

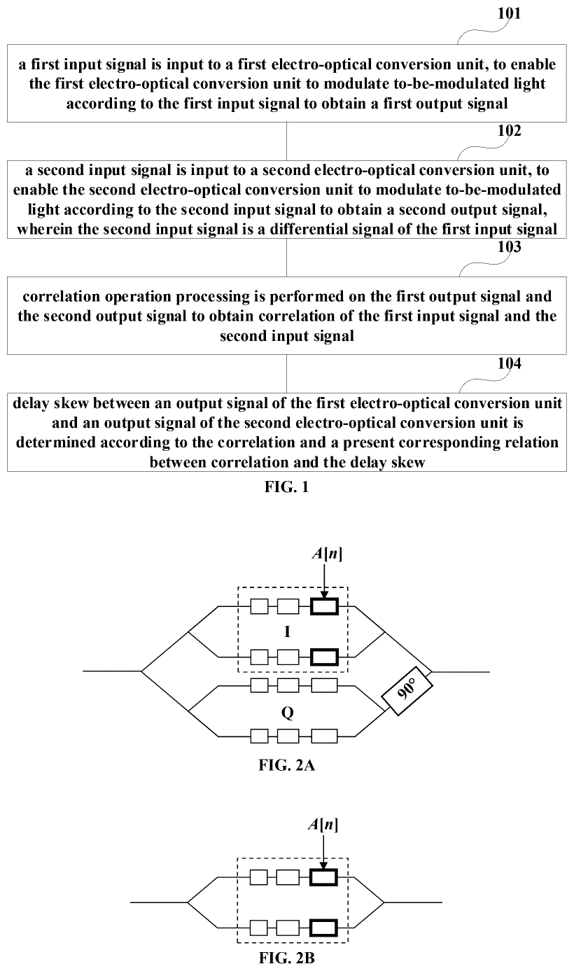

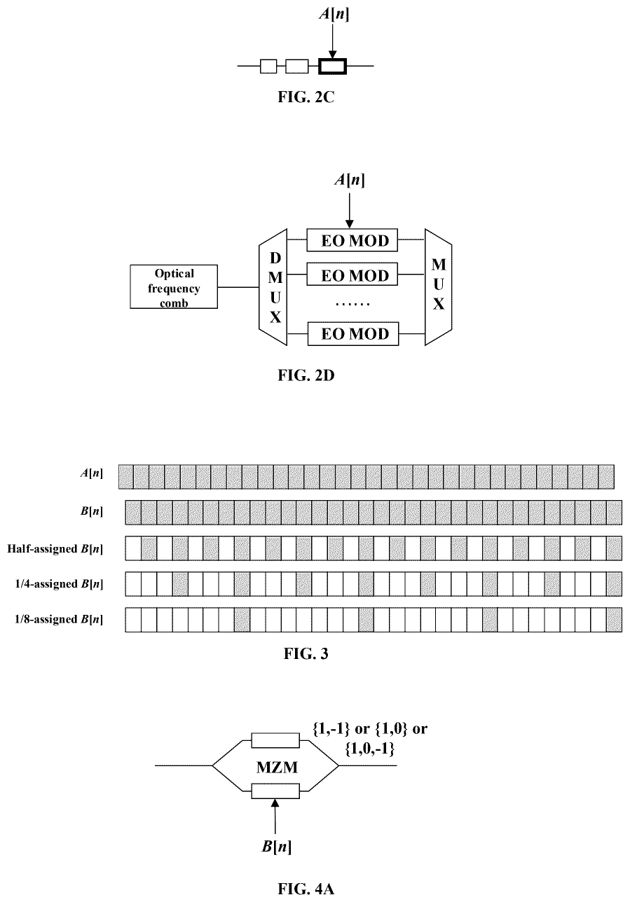

FIG. 2A to FIG. 2D are schematic diagrams of a first electro-optical conversion unit in the embodiments of the present disclosure. FIG. 2A shows an IQ modulator with a plurality of sub-signal branches in a coherent transmitter, both I channel and Q channel of the IQ modulator have a plurality of modulation units. The first electro-optical conversion unit in FIG. 2A may be any one modulation unit in the IQ modulator, such as a modulation unit corresponding to the first symbol sequence A[n] on the I channel, that is, a modulation unit input by the first symbol sequence A[n]. In FIG. 2B, the first electro-optical conversion unit is a modulation unit corresponding to the first symbol sequence A[n] in a segmented intensity modulator. In FIG. 2C, the first electro-optical conversion unit is a modulation unit corresponding to the first symbol sequence A[n] in a segmented phase modulator. In FIG. 2D, the first electro-optical conversion unit is an EO MOD unit corresponding to the first symbol sequence A[n] in a combination signal transmitter based on an optical frequency comb. In addition to the structures shown in FIG. 2A to FIG. 2D, the first electro-optic conversion unit may further adopt other structures, the present disclosure has no limitation in this regard.

In the operation 102, a second input signal is input to a second electro-optical conversion unit, to enable the second electro-optical conversion unit to modulate to-be-modulated light according to the second input signal to obtain a second output signal; wherein the second input signal is a differential signal of the first input signal.

In some embodiments, the second input signal is a differential signal of the first input signal A[n], and it is denoted as a second input signal B[n] in the present disclosure, where, n denotes a time sequence number. The second electro-optical conversion unit modulates to-be-modulated light input thereto according to the second input signal B[n], to obtain a second output signal, the second output signal is also a high-speed signal and an optical signal. The to-be-modulated light of the second electro-optical conversion unit may be the same as or different from the to-be-modulated light corresponding to the first electro-optical conversion unit.

In some embodiments, the differential signal of the first input signal, i.e., the second input signal, is a difference of the first input signal at two different moments.

For example, the first input signal A[n] at two different moments is denoted as A[n+k₁] and A[n+k₂] respectively, k₁ and k₂ are integers and k₁≠k₂. The second input signal B[n] is a difference of A[n+k₁] and A[n+k₂], i.e., B[n]=A[n+k₁]−A[n+k₂].

In some embodiments, the differential signal of the first input signal, i.e., the second input signal, is a symbol sequence of a difference of the first input signal at two different moments.

For example, the first input signal A[n] at two different moments is denoted as A[n+k₁] and A[n+k₂] respectively, k₁ and k₂ are integers and k₁≠k₂, and the symbolic function is sign( ). The second input signal B[n] is a symbol sequence of a difference of A[n+k₁] and A[n+k₂], i.e., B[n]=sign(A[n+k₁]−A[n+k₂]).

In some embodiments, the differential signal of the first input signal, i.e., the second input signal, is a product of a symbol sequence of a difference of the first input signal at two different moments and a finite number of a random amplitude sequence.

For example, the first input signal A[n] at two different moments is denoted as A[n+k₁] and A[n+k₂] respectively, k₁ and k₁ are integers and k₁≠k₂, and the finite number of the random amplitude sequence is Amp₁[n]. The second input signal B[n] is a product of a symbol sequence of a difference of A[n+k₁] and A[n+k₂] and Amp₁[n], i.e., B[n]=Amp₁[n]*sign(A[n+k₁]−A[n+k₂]), where, Amp₁[n] is e.g., a random amplitude sequence with a series of positive values.

In some embodiments, the differential signal of the first input signal, i.e., the second input signal, is a product of a symbol sequence of a difference of the first input signal at two different moments and an infinite number of a random amplitude sequence.

For example, the first input signal A[n] at two different moments is denoted as A[n+k₁] and A[n+k₂] respectively, k₁ and k₂ are integers and k₁≠k₂, and the infinite number of the random amplitude sequence is Amp₂[n]. The second input signal B[n] is a product of a symbol sequence of a difference of A[n+k₁] and A[n+k₂] and Amp₂[n], i.e., B[n]=Amp₂[n]*sign(A[n+k₁]−A[n+k₂]), where, Amp₂[n] is e.g., a random amplitude sequence with a series of positive values.

In some embodiments, the second input signal is enabled to operate at intervals. The meaning of operating at intervals is that a signal input into the second electro-optical conversion unit is not assigned a second input signal B[n] at all moments, but is assigned a second input signal B[n] at some moments. Thus, at a pre-set moment, the second input signal B[n] is input to the second electro-optical conversion unit; at a moment other than the pre-set moment, 0 signal or a signal unrelated to the first input signal A[n] is input to the second electro-optical conversion unit.

In some embodiments, the pre-set moment may be a periodically occurring moment, even though the second input signal operates at a fixed periodic interval. For example, FIG. 3 is a schematic diagram in which a second input signal operates at intervals in the embodiments of the present disclosure. FIG. 3 shows five rows of squares, each square in each row represents a moment, and a square whose background color is white represents that a moment to which it corresponds is assigned with a signal marked on the left side of the square. As shown in FIG. 3, the first row of squares represents that at all moments, the first input signal A[n] is input to the first electro-optic conversion unit; the second row of squares represents that at all moments, the second input signal B[n] is input to the second electro-optic conversion unit; the third row of squares represents that the second input signal operates at a ½ rate interval (half-assigned B[n]), that is, by taking two moments as a period, at one moment contained in each period, the second input signal B[n] is input to the second electro-optical conversion unit; the fourth row of squares represents that the second input signal operates at a ¼ rate interval (¼-assigned B[n]), that is, by taking four moments as a period, at one moment contained in each period, the second input signal B[n] is input to the second electro-optical conversion unit; and the fifth row of squares represents that the second input signal operates at a ⅛ rate interval (⅛-assigned B[n]), that is, by taking eight moments as a period, at one moment contained in each period, the second input signal B[n] is input to the second electro-optical conversion unit.

In practical application, a length of an interval operating period of the second input signal B[n] is not limited to the above examples.

In some embodiments, the pre-set moment may be a randomly selected moment, also even if the second input signal operates at random intervals.

In the above embodiments, by making the second input signal operate at intervals, a moment to input the second input signal is reduced, a calculated correlation is also reduced accordingly, which is conducive to reducing power consumption of a real-time monitoring operation of a sub-signal delay skew of an optical transmitter.

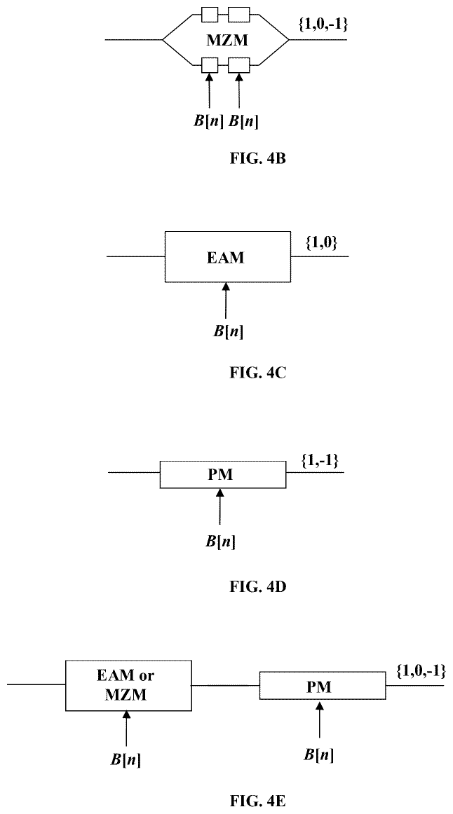

In some embodiments, the second electro-optical conversion unit is a unit with a modulation function and being capable of generating a high-speed signal. In the present disclosure, the second electro-optical conversion unit may be an existing electro-optical conversion unit. FIG. 4A to FIG. 4E are schematic diagrams of a second electro-optical conversion unit in the embodiments of the present disclosure. In FIG. 4A, the second electro-optical conversion unit is an MZ-type modulator (MZM) with a modulation unit. In FIG. 4B, the second electro-optical conversion unit is an MZ-type modulator (MZM) with two modulation units having an equal length. In FIG. 4C, the second electro-optical conversion unit is an electro absorption modulator (EAM). In FIG. 4D, the second electro-optical conversion unit is a phase modulator (PM). In FIG. 4E, the second electro-optical conversion unit is a structure in which an amplitude modulator (such as an MZ-type modulator (MZM) or an electro absorption modulator (EAM)) and a phase modulator (PM) are connected in series. In addition to the structures shown in FIG. 4A to FIG. 4E, the second electro-optic conversion unit may further adopt other structures, the present disclosure has no limitation in this regard.

In some embodiments, the second output signal output by the second electro-optical conversion unit is a continuous signal.

In some embodiments, the second electro-optical conversion unit outputs a finite number of states, i.e., the second output signal output by the second electro-optical conversion unit is a finite number of discrete signal. For example, a set of values of the second output signal output by the second electro-optical conversion unit may be {1, −1}, {1, 0} or {1, 0, −1}, etc. For example, for the second electro-optical conversion unit shown in FIG. 4A, a value of a second input signal B[n] input by it is ±1, and a value of a symbol sequence output by it may be {1, −1}, {1, 0} or {1, 0, −1}. For the second electro-optical conversion unit shown in FIG. 4B, a value of a second input signal B[n] input by it is ±1, and a value of a symbol sequence output by it may be {1, 0, −1}. For the second electro-optical conversion unit shown in FIG. 4C, a value of a second symbol sequence B[n] input by it is 1 and 0, and a value of a symbol sequence output by it may be {1, 0}. For the second electro-optical conversion unit shown in FIG. 4D, a value of a second symbol sequence B[n] input by it is ±1, and a value of a symbol sequence output by it may be {1, −1}. For the second electro-optical conversion unit shown in FIG. 4E, when it is a structure in which an MZ-type modulator (MZM) and a phase modulator (PM) are connected in series, a value of a second symbol sequence B[n] input by the MZM is ±1, a value of a second symbol sequence B[n] input by the PM is ±1, and a value of a symbol sequence output by the second electro-optical conversion unit may be {1, 0, −1}. When it is a structure in which an electro absorption modulator (EAM) and a phase modulator (PM) are connected in series, a value of a second symbol sequence B[n] input by the EAM is 1 and 0, a value of a second symbol sequence B[n] input by the PM is ±1, and a value of a symbol sequence output by the second electro-optical conversion unit may be {1, 0, −1}.

When the second electro-optical conversion unit only outputs a finite number of states, the second electro-optical conversion unit only needs logical operation, its complexity, cost and power consumption are all reduced.

In the operation 103, correlation operation processing on the first output signal and the second output signal is performed to obtain correlation of the first input signal and the second input signal.

In some embodiments, that correlation operation processing on the first output signal and the second output signal is performed includes: multiplying the first output signal and the second output signal to obtain a product signal of the first output signal and the second output signal; and, performing electrical average operation on the product signal, thereby correlation of the first output signal and the second output signal may be obtained.

In some embodiments, the product signal of the first output signal and the second output signal is determined via a photoelectric method.

When the photoelectric method is adopted, the first electro-optical conversion unit and the second electro-optical conversion unit are connected in parallel. In this case, the first electro-optical conversion unit outputs an optical signal of the first output signal, and the second electro-optical conversion unit outputs an optical signal of the second output signal. Subsequently, the optical signal of the first output signal and the optical signal of the second output signal are combined into an optical signal, photoelectric conversion and multiplication operations are performed on the combined optical signal, whereby a product signal of the first output signal and the second output signal is obtained, and the product signal is an electrical signal.

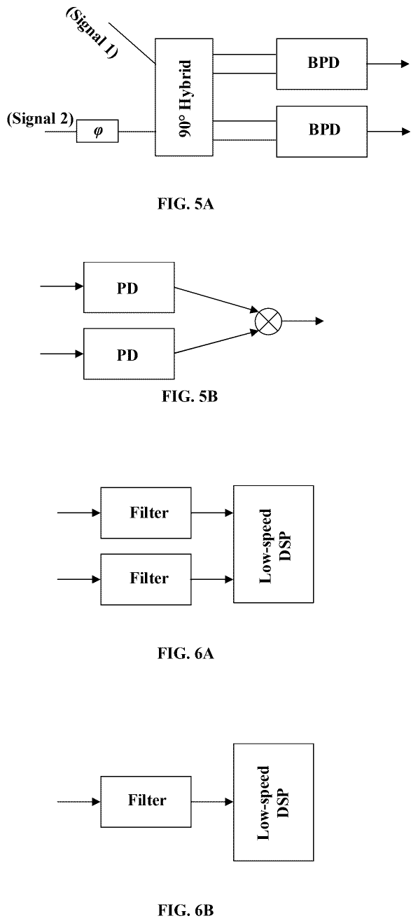

In some embodiments, the photoelectric method is implemented via a photoelectric multiplier, for example photoelectric conversion and multiplication operations are performed by using a photoelectric detector, a balanced detector, a coherent detector, etc. FIG. 5A to FIG. 5B are schematic diagrams of a photoelectric multiplier in the embodiments of the present disclosure. In FIG. 5A, the photoelectric multiplier includes a phase shifter ((p), a 90-degree frequency mixer (90° hybrid) and two balanced detectors (BPD), in which the phase shifter ((p) is optional, that is, the phase shifter may or may not be included in FIG. 5A. In FIG. 5A, the photoelectric multiplier has two input signals, i.e., signal 1 and signal 2. In the present disclosure, one of signal 1 and signal 2 is an optical signal of the first output signal output by the first electro-optical conversion unit, and the other of signal 1 and signal 2 is an optical signal of the second output signal output by the second electro-optical conversion unit. The output signal of the photoelectric multiplier includes a product signal of the first output signal and the second output signal.

In FIG. 5B, the photoelectric multiplier includes two single detectors (PDs) and a multiplier. The input of one of the two PDs is an optical signal of the first output signal output by the first electro-optical conversion unit, and the output thereof is an electrical signal of the first output signal; the input of the other one of the two PDs is an optical signal of the second output signal output by the second electro-optical conversion unit, and the output thereof is an electrical signal of the second output signal. The multiplier is used to calculate and output a product signal of the electrical signal of the first output signal and the electrical signal of the second output signal.

In addition to the structures shown in FIG. 5A to FIG. 5B, the photoelectric multiplier may further adopt other structures, the present disclosure has no limitation in this regard.

In some embodiments, the product signal of the first output signal and the second output signal is determined via an optical method.

When the optical method is adopted, the first electro-optical conversion unit and the second electro-optical conversion unit are connected in series to form an optical multiplier. The optical multiplier implements multiplication of the first output signal and the second output signal in an optical domain, thus the optical multiplier directly outputs an optical signal of a product of the first output signal and the second output signal. Then, photoelectric conversion is performed on the optical signal of the product, thereby the electrical signal of the product of the first output signal and the second output signal is obtained, that is, the product signal.

In some embodiments, photoelectric conversion is implemented by a photoelectric conversion unit. The structure of the photoelectric conversion unit for example is similar to that of the photoelectric multiplier shown in FIG. 5A to FIG. 5B. A difference is that when the optical method is used, the photoelectric multiplier in FIG. 5A is used as a photoelectric conversion unit.

In this case, one of two input signals, i.e., signal 1 and signal 2, is a signal output after the first electro-optical conversion unit and the second electro-optical conversion unit are connected in series, that is, an optical signal of a product of a first output signal and a second output signal, and the other is direct current light.

In addition to the structures shown in FIG. 5A to FIG. 5B, the photoelectric conversion unit may further adopt other structures, the present disclosure has no limitation in this regard.

In some embodiments, electrical average operation is performed on a product signal of the first output signal and the second output signal to obtain correlation of the first output signal and the second output signal.

The electrical average operation may be implemented in an analog domain, for example, the electrical average operation on the product signal may be implemented via an analog circuit. The electrical average operation may further be implemented in a digital domain, for example, after analog-to-digital conversion is performed on the product signal, the electrical average operation of a digital signal corresponding to the product signal is implemented via a digital circuit.

In some embodiments, the electrical average operation is implemented via an electrical average unit. For example, signal averaging is achieved via a low-pass filter or a low-speed DSP. FIG. 6A to FIG. 6B are schematic diagrams of an electrical average unit in the embodiments of the present disclosure. In FIG. 6A, the electrical average unit includes two low-pass filters and one low-speed digital signal processor (low-speed DSP). In FIG. 6B, the electrical average unit includes one low-pass filter and one low-speed digital signal processor (low-speed DSP).

In addition to the structures shown in FIG. 6A to FIG. 6B, the electrical average unit may further adopt other structures, the present disclosure has no limitation in this regard.

The photoelectric multiplier and the electrical average units in the present disclosure constitute relevant operation units, or the photoelectric multiplier, the photoelectric conversion units and the electrical average unit constitute relevant operation units. A structure for determining the correlation of the first output signal and the second output signal is exemplarily described below through embodiments, however a mode in which the present disclosure implements relevant operations is not limited to this.

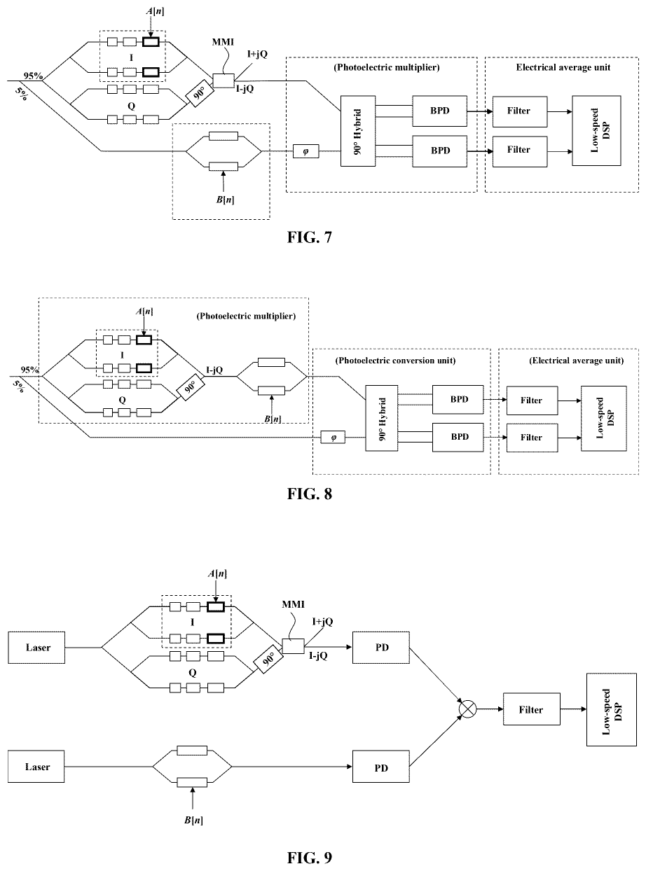

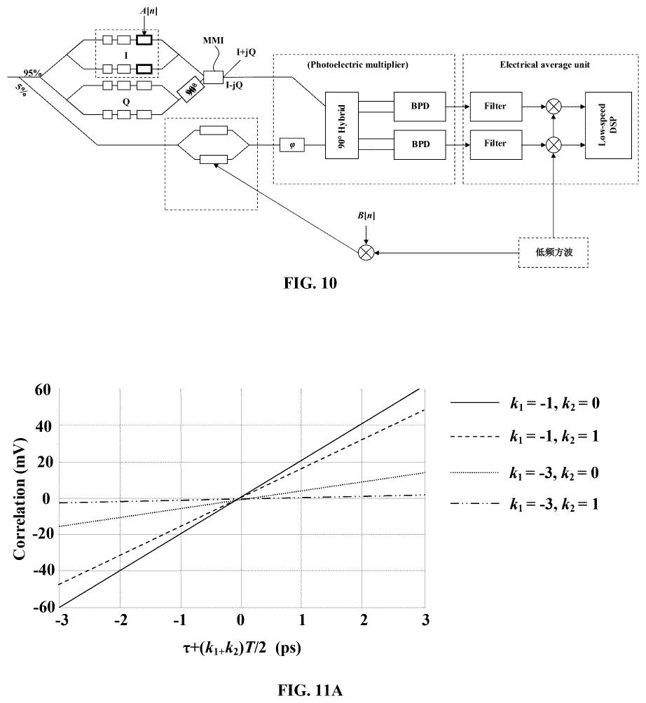

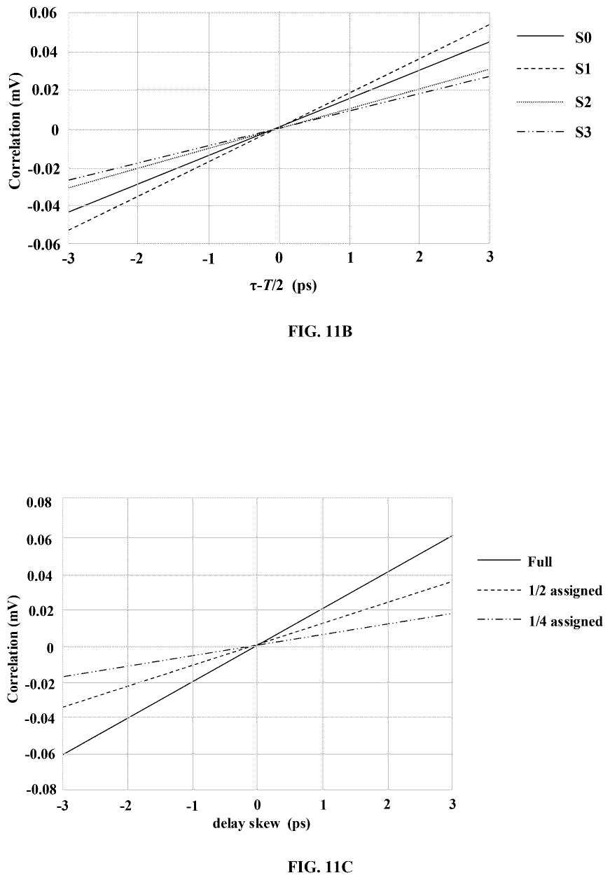

FIG. 7 to FIG. 10 are schematic diagrams of a hardware structure for determining a correlation in the embodiments of the present disclosure. The hardware structure shown in FIG. 7, FIG. 9 and FIG. 10 include a first electro-optical conversion unit, a second electro-optical conversion unit, a photoelectric multiplier and an electrical average unit. The hardware structure shown in FIG. 8 includes a first electro-optical conversion unit, a second electro-optical conversion unit, a photoelectric conversion unit and an electrical average unit. And the first electro-optical conversion unit may be any of the first electro-optical conversion units shown in FIG. 2A to FIG. 2D, or other structures. The second electro-optical conversion unit may be any of the second electro-optical conversion units shown in FIG. 4A to FIG. 4E, or other structures. The photoelectric multiplier or the photoelectric conversion unit may be any of the photoelectric multipliers shown in FIG. 5A to FIG. 5B, or other structures. The electrical average unit may be any of the electrical average units shown in FIG. 6A to FIG. 6B, or other structures.

For example, in the hardware structure shown in FIG. 7, the first electro-optical conversion unit shown in FIG. 2A, the second electro-optical conversion unit shown in FIG. 4A, the photoelectric multiplier shown in FIG. 5A, and the electrical average unit shown in FIG. 6A are adopted. In FIG. 7, the first electro-optical conversion unit and the second electro-optical conversion unit are connected in parallel, to-be-modulated light of the first electro-optical conversion unit and of the second electro-optical conversion unit are direct current light output by the same laser, and before a modulator, part of the direct current light (e.g. 95%) is transmitted to the first electro-optical conversion unit, and the other part (e.g. 5%) is transmitted to the second electro-optical conversion unit. A coherent transmitter has a plurality of output ports, so a first output signal output by it may be included in an output signal I+jQ at an I+jQ detection end, or in an output signal I−jQ at an I−jQ detection end, or in an output signal of other detection branches. Acquisition of the first output signal may be achieved by a beam splitter, through which a part (e.g. 5%) of the output signal of a corresponding branch is split, and it is applied in the present disclosure as the first output signal, and for details, prior arts may be referred to. FIG. 7 takes that the first output signal is included in an output signal I−jQ at an I−jQ detection end as an example, however the present disclosure is not limited to this.

Inputs of the photoelectric multiplier are a first output signal output by the first electro-optical conversion unit and a second output signal output by the second electro-optical conversion unit, and outputs of the photoelectric multiplier is two electrical signals in an in-phase channel and a quadrature channel. Low-pass filtering of an electrical signal and low-speed DSP constitute an electrical average unit, and an electrical average operation may be implemented in an analog domain or a digital domain.

For another example, in the hardware structure shown in FIG. 8, the first electro-optical conversion unit shown in FIG. 2A, the second electro-optical conversion unit shown in FIG. 4A, the photoelectric conversion unit shown in FIG. 5A, and the electrical average unit shown in FIG. 6A are adopted. In FIG. 8, the first electro-optical conversion unit and the second electro-optical conversion unit are connected in series, and form an optical multiplier, so that the first output signal and the second output signal multiply on the optical domain. Before a modulator, a part (e.g. 95%) of direct current light output by a laser is transmitted to the first electro-optical conversion unit which forms the first output signal. The first output signal is included in an output signal of an output port (such as an I+jQ detection end or an I−jQ detection end or other detection end) of the coherent transmitter. An input end of the second electro-optical conversion unit is connected with a corresponding output port of the coherent transmitter, and an input signal containing the first output signal is modulated, thereby a product of the first output signal and the second output signal is output in the optical domain.

Two inputs of the photoelectric conversion unit are respectively a product of the first output signal and the second output signal in the optical domain, and a part (such as 5%) of the direct current light that is split.

For a further example, in the hardware structure shown in FIG. 9, the first electro-optical conversion unit shown in FIG. 2A, the second electro-optical conversion unit shown in FIG. 4A, the photoelectric conversion unit shown in FIG. 5B, and the electrical average unit shown in FIG. 6B are adopted. In FIG. 9, the first electro-optical conversion unit and the second electro-optical conversion unit are connected in parallel, to-be-modulated light of the first electro-optical conversion unit and the second electro-optical conversion unit are direct current light output by the same laser or different lasers. The first output signal of the first electro-optical conversion unit and the second output signal of the second electro-optical conversion unit are detected by a PD respectively, and then are multiplied electrically via a multiplier, and then are averaged electrically via an electrical average unit, whereby correlation of the first output signal and the second output signal are obtained.

In some embodiments, an operation of multiplying a square wave with a frequency shift is further included in the process of performing correlation operations. Specifically, the second input signal is multiplied with a low-frequency square wave, and a product of the second input signal and the low-frequency square wave is input into the second electro-optical conversion unit; accordingly, in correlation operation processing, a product signal of the first output signal of the first electro-optical conversion unit and the second output signal of the second electro-optical conversion unit is multiplied with the low-frequency square wave, and then an electrical average operation is performed on a product of the product signal and the low-frequency square wave to obtain the correlation of the first output signal and the second output signal.

In FIG. 10, on the basis of the hardware structure shown in FIG. 7, a multiplier is set before the input of the second electro-optical conversion unit to implement multiplication of the second input signal with the low-frequency square wave, and a multiplier is set between a low-pass filter of the electrical average unit and a low-speed digital signal processor (low-speed DSP) to implement multiplication of a product signal of the first output signal and the second output signal with the low-frequency square wave. In addition, an operation of multiplying a square wave with a frequency shift may be added on the basis of FIGS. 8, 9 and other hardware structures capable of implementing the relevant operations, and the present disclosure does not make limitations in this regard.

Through the above embodiments, in the present disclosure, a step of multiplying a square wave with a frequency shift is added to the method for real-time monitoring delay skew of a sub-signal of an optical transmitter, that is, the product of the low-frequency square wave and the second input signal is taken as an input of the second electro-optical conversion unit, and in the electrical average unit, an electrical average operation is performed on a product of a product signal of the first output signal and the second output signal and the low-frequency square wave to obtain correlation of the first output signal and the second output signal. After the operation of multiplying a square wave with a frequency shift is added, a calculated correlation may be transferred from DC to a frequency of a low-frequency square wave, so as to avoid 1/f noise near DC.

In the operation 104, determining delay skew between an output signal of the first electro-optical conversion unit and an output signal of the second electro-optical conversion unit according to the correlation of the first output signal and the second output signal and a pre-set corresponding relation between correlation and the delay skew.

In some embodiments, the first input signal is input to the first electro-optical conversion unit which outputs the first output signal, and the second input signal is input to the second electro-optical conversion unit which outputs the second output signal, and the correlation of the first output signal and the second output signal indicate delay skew between the output signals of the first electro-optical conversion unit and the second electro-optical conversion unit. A corresponding relationship between the correlation and the delay skew is: a sum of the delay skew and a constant are proportional to the correlation, where, the constant is related to the second input signal. As described above, the second input signal is a differential signal of the first input signal at two different moments, and the constant is related to selection of the “two different moments”.

For example, the first input signal is A[n], the second input signal is a differential signal of the first input signals A[n+k₁] and A[n+k₂] at two different moments, k₁ and k₂ are integers and k₁≠k₂; in this case, a corresponding relationship between the correlation and the delay skew is expressed as:

$$S = k * ( τ + ( {k}_{1 +} {k}_{2} ) T / 2 )$$

where, S is a correlation between the first output signal and the second output signal, T is delay skew between the first electro-optical conversion unit and the second electro-optical conversion unit, T is a unit time length corresponding to the time sequence number n, k₁ and k₂ are integers and k₁≠k₂, and k is a known quantity related to k₁ and k₂.

Seen as such, the above constant is (k₁+k₂)T/2. When the selected “two different moments” are different, k₁ and k₁ are different, (k₁+k₂) may be different, thereby the above constant i.e., (k₁+k₂)T/2 may also be different.

FIG. 11A to FIG. 11C are schematic diagrams of a corresponding relation between a correlation and delay skew in the embodiments of the present disclosure. FIG. 11A shows a situation in which k₁ and k₂ take values (−1,0), (−1,1), (−3,0), and (−3,1) respectively. In practical applications, k₁ and k₂ may further be other different combinations, the present disclosure does not limit in this regard.

In the present disclosure, “a corresponding relationship between a correlation and delay skew” corresponding to different combinations of k₁ and k₂ may be pre-stored in a memory. In the delay skew real-time monitoring process, when the values of k₁ and k₂ are given, a pre-set corresponding relationship between correlation and delay skew may be found according to the values of k₁ and k₂, thereby according to correlation of the first output signal of the first electro-optical conversion unit and the second output signal of the second electro-optical conversion unit and the found corresponding relationship, a value of (τ+(k₁+k₂)T/2) is determined, whereby delay skew T is obtained.

In FIG. 11A, that the second input signal is a difference of the first input signal at two different moments is taken as an example. When the second input signal is a symbol sequence of a difference of the first input signal at two different moments, or a product of the symbol sequence of the difference of the first input signal at two different moments and a random amplitude function with finite values, or a product of the symbol sequence of the difference of the first input signal at two different moments and a random amplitude function with infinite values, the above corresponding relationship between the correlation and the delay skew also applies.

For example, FIG. 11B shows a corresponding relationship between a correlation and delay skew when k₁ and k₂ take values (−1,0) respectively, and the second input signal adopts different forms of differential signals of the first input signal. In FIG. 11B, curve S0 represents a corresponding relationship between correlation of the first output signal and the second output signal and delay skew of output signals of the first electro-optical conversion unit and the second electro-optical conversion unit when the second input signal B[n]=A[n+k₁]−A[n+k₂]. Curve S1 represents a corresponding relationship between correlation of the first output signal and the second output signal and delay skew of output signals of the first electro-optical conversion unit and the second electro-optical conversion unit when the second input signal B[n]=sign(A[n+k₁]−A[n+k₂]). Curve S2 represents a corresponding relationship between correlation of the first output signal and the second output signal and delay skew of output signals of the first electro-optical conversion unit and the second electro-optical conversion unit when the second input signal B[n]=Amp₁[n]*sign(A[n+k₁]−A[n+k₂]), and Amp₁[n] is a finite number of a random amplitude sequence. Curve S3 represents a corresponding relationship between correlation of the first output signal and the second output signal and delay skew of output signals of the first electro-optical conversion unit and the second electro-optical conversion unit when the second input signal B[n]=Amp₂[n]*sign(A[n+k₁]−A[n+k₂]), and Amp₂[n] is an infinite number of a random amplitude sequence.

In addition, corresponding to the second input signal that operates at intervals, the corresponding relationship between the correlation and the delay skew also applies.

For example, FIG. 11C shows a corresponding relationship between a correlation and delay skew for the same second input signal B[n] when it is operated in different ways. In FIG. 11C, curve Full represents a corresponding relationship between correlation of the first output signal and the second output signal and delay skew of output signals of the first electro-optical conversion unit and the second electro-optical conversion unit when the second input signal is assigned a value to operate at all moments (corresponding to the second row of square grids in FIG. 3). Curve Half-assigned B[n] represents a corresponding relationship between correlation of the first output signal and the second output signal and delay skew of output signals of the first electro-optical conversion unit and the second electro-optical conversion unit when the second input signal operates at ½ rate intervals (corresponding to the third row of square grids in FIG. 3). Curve ¼-assigned B[n] represents a corresponding relationship between correlation of the first output signal and the second output signal and delay skew of output signals of the first electro-optical conversion unit and the second electro-optical conversion unit when the second input signal operates at ¼ rate intervals (corresponding to the fourth row of square grids in FIG. 3).

In FIG. 11A to FIG. 11C, the unit of the correlation is millivolt (mV), and the unit of the delay skew is picosecond (ps). In practical application, units of the correlation and the delay skew may be different from these, correspondingly, a slope of a corresponding curve may further be different, the present disclosure is not limited to this.

In some embodiments, when responses of the first electro-optical conversion unit and the second electro-optical conversion unit are the same, and the correlation of the first output signal of the first electro-optical conversion unit and the second output signal of the second electro-optical conversion unit is 0, delay of output signals of the first electro-optical conversion unit and the second electro-optical conversion unit are aligned.

In the real-time monitoring process, the second input signal of the second electro-optic conversion unit is a differential signal of the first output signal of the first electro-optic conversion unit. Therefore, even if delay of output signals of the first electro-optical conversion unit and the second electro-optical conversion unit are aligned, delay skew obtained through the above steps is not necessarily 0. For example, in FIG. 11A, when k₁ and k₂ take value (−1, 1) respectively, responses of the first electro-optical conversion unit and the second electro-optical conversion unit are the same, and the correlation of the first output signal of the first electro-optical conversion unit and the second output signal of the second electro-optical conversion unit is 0, delay of output signals of the first electro-optical conversion unit and the second electro-optical conversion unit are aligned. In this case, delay of output signals of the first electro-optical conversion unit and the second electro-optical conversion unit, as obtained through the above steps, are 0. However, when k₁ and k₂ take value (−1, 0) respectively, responses of the first electro-optical conversion unit and the second electro-optical conversion unit are the same, and the correlation of the first output signal of the first electro-optical conversion unit and the second output signal of the second electro-optical conversion unit is 0, delay of output signals of the first electro-optical conversion unit and the second electro-optical conversion unit are aligned. In this case, delay skew of output signals of the first electro-optical conversion unit and the second electro-optical conversion unit, as obtained through the above steps, is T12 picoseconds.

In some embodiments, the method for real-time monitoring delay skew of a sub-signal of an optical transmitter further includes:

determining, respectively according to the correlation of the first output signals of a plurality of different first electro-optical conversion units and the second output signal of the same second electro-optical conversion unit and a corresponding relation between a correlation corresponding to the correlation and delay skew, delay skew between output signals of a plurality of the first electro-optical conversion units and an output signal of the second electro-optical conversion unit; and calibrating delay between the plurality of the first electro-optical conversion units based on each of the delay skew.

In some embodiments, calibrating delay between the plurality of first electro-optical conversion units based on each of the delay skew includes: determining a reference delay skew of output signals of each of the first electro-optical conversion unit and the same second electro-optical conversion unit; wherein the reference delay skew is a value of delay skew when a correlation is 0 in a corresponding relationship between the corresponding correlation and the delay skew; determining a difference between each of the delay skew and a corresponding reference delay skew; and calibrating delay of the corresponding first electro-optical conversion unit and the second electro-optical conversion unit according to the difference.

Since the correlation is 0, it is considered that delay of output signals of the corresponding first electro-optical conversion unit and the second electro-optical conversion unit are aligned, after delay of the output signal of the corresponding first electro-optical conversion unit is calibrated according to the difference, delay of output signals of each of the first electro-optical conversion units and the second electro-optical conversion unit are aligned, and delay skew of the output signal of each of the first electro-optical conversion units is 0.

For example, assuming that N different first electro-optical conversion units are Tx11, Tx12, . . . , Tx1N, and the second electro-optical conversion unit is Tx2. Through steps 101 to 104 in the present disclosure, delay skew of output signals of N first electro-optical conversion units and the second electro-optical conversion unit Tx2 is determined to respectively be τ11, τ12, . . . , TiN, a reference delay skew of output signals of N first electro-optical conversion units and the second electro-optical conversion unit Tx2 is determined to respectively be τ01, τ02, . . . , τ0N, then a difference between the delay skew corresponding to N first electro-optical conversion units and the reference delay skew is: (τ11−τ01), (τ12−τ02), . . . , (τ1N−τ0N), respectively. In this case, the delay of the output signal of the first electro-optical conversion unit Tx11 is adjusted by [−(τ11−τ01)], the delay of the output signal of the first electro-optical conversion unit Tx12 is adjusted by [−(τ12−τ02)], . . . , and the delay of the output signal of the first electro-optical conversion unit Tx1N is adjusted by [−(τ1N−τ0N)]. After the above adjustment, delay of the output signals of the N first electro-optical conversion units are the same, and the delay skew is 0. Therefore, delay calibration of quality inspection of different first electro-optical conversion units is implemented.

The above text schematically describes a method for real-time monitoring delay skew of a sub-signal of an optical transmitter and some hardware structures for implementing the method, however the present disclosure is not limited to this. The method for real-time monitoring delay skew of a sub-signal of an optical transmitter may further include other steps or processes. For specific contents of these steps or processes, please refer to prior arts. In addition, the above text exemplarily describes hardware structures for implementing the method for real-time monitoring delay skew of a sub-signal of an optical transmitter, however the present disclosure is not limited to these hardware structures, these structures may further be modified appropriately, implementations of such modifications should be included within the scope of the embodiments of the present disclosure.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, in the present disclosure, delay skew is determined using a signal output by an electro-optical conversion unit of an optical transmitter, real-time monitoring of the delay skew is implemented, and there is no need for the optical transmitter to transmit a special signal; moreover, in the present disclosure, sub-signal delay skew monitoring of the optical transmitter may be implemented by using a low-bandwidth electrical device, which avoids use of a high-speed equipment, and may be flexibly implemented via an integrated or non-integrated mode; in addition, application scenarios of the present disclosure are rich, and are suitable for sub-signal delay skew monitoring in a variety of optical transmitters.

### Embodiments of a Second Aspect

Embodiments of the present disclosure provide an apparatus for real-time monitoring delay skew of a sub-signal of an optical transmitter, the contents same as the embodiments of the first aspect are not repeated.

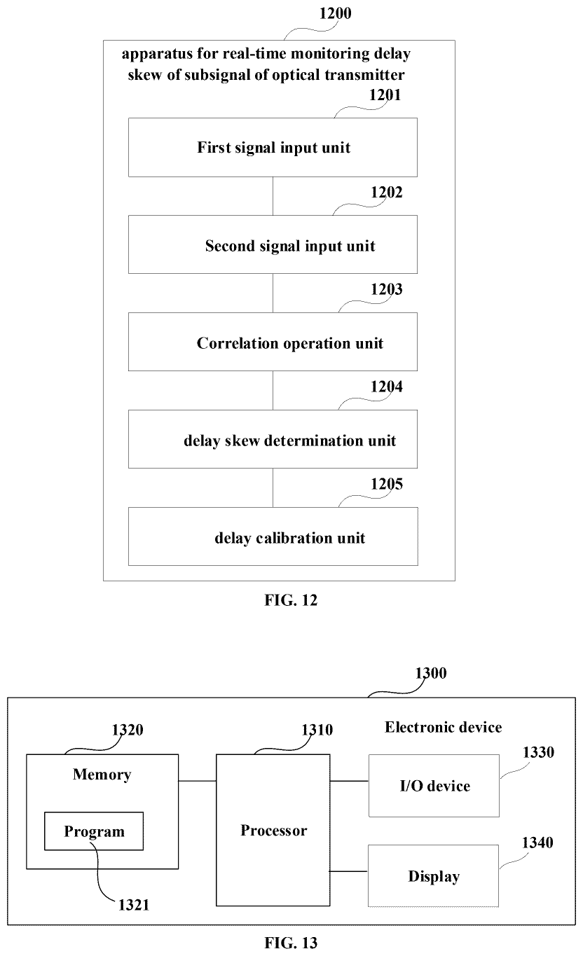

FIG. 12 is a schematic diagram of an apparatus for real-time monitoring delay skew of a sub-signal of an optical transmitter in the embodiments of the present disclosure. As shown in FIG. 12, an apparatus 1200 for real-time monitoring delay skew of a sub-signal of an optical transmitter includes: a first signal input unit 1201, configured to input a first input signal to a first electro-optical conversion unit, to enable the first electro-optical conversion unit to modulate to-be-modulated light according to the first input signal and to obtain a first output signal; a second signal input unit 1202, configured to input a second input signal to a second electro-optical conversion unit, to enable the second electro-optical conversion unit to modulate to-be-modulated light according to the second input signal and to obtain a second output signal, wherein the second input signal is a differential signal of the first input signal; a correlation operation unit 1203, configured to perform correlation operation processing on the first output signal and the second output signal to obtain correlation of the first input signal and the second input signal; a delay skew determination unit 1204, configured to determine delay skew between an output signal of the first electro-optical conversion unit and an output signal of the second electro-optical conversion unit according to the correlation and a pre-set corresponding relation between correlation and the delay skew.

In some embodiments, the first electro-optical conversion unit is a transmitter, or a partial modulation unit of the transmitter.

In some embodiments, the second electro-optical conversion unit outputs a finite number of states.

In some embodiments, the differential signal of the first input signal includes: a difference of the first input signal at two different moments; or a symbol sequence of the difference of the first input signal at two different moments; or a product of the symbol sequence of the difference of the first input signal at two different moments and a finite number of random amplitude sequence; or a product of the symbol sequence of the difference of the first input signal at two different moments and an infinite number of random amplitude sequence.

In some embodiments, the correlation operation unit 1203 is specifically used to: determine a product signal of the first output signal and the second output signal via a photoelectric method or an optical method; and perform an electrical average operation on the product signal to obtain correlation of the first input signal and the second input signal.

In some embodiments, the first input signal is A[n], the second input signal is a differential signal of the first input signals A[n+k₁] and A[n+k₂] at two different moments, k₁ and k₂ are integers and k₁≠k₂; the corresponding relation between the correlation and the delay skew includes:

$$S = k * ( τ + ( {k}_{1 +} {k}_{2} ) T / 2 )$$

where, S is the correlation, r is delay skew between the first electro-optical conversion unit and the second electro-optical conversion unit, Tis a unit time length corresponding to the time sequence number n, k₁ and k₂ are integers and k₁≠k₂, and k is a known quantity related to k₁ and k₂.

In some embodiments, the second signal input unit 1202 is specifically used to: at a pre-set time, input the second input signal to the second electro-optical conversion unit; and at a moment other than the pre-set moment, input a signal unrelated to the first input signal or a 0 signal to the second electro-optical conversion unit.

In some embodiments, the delay skew determination unit 1204 is further used to: determine, respectively according to correlation of the output signals of a plurality of first electro-optical conversion units and the output signal of the second electro-optical conversion unit and a corresponding relation between correlation corresponding to the correlation and delay skew, delay skew between an output signal of each of the first electro-optical conversion units and an output signal of the second electro-optical conversion unit; and the apparatus 1200 further includes a delay calibration unit 1205, configured to calibrate delay between the plurality of first electro-optical conversion units based on each of the delay skew.

In some embodiments, to-be-modulated light corresponding to the first electro-optical conversion unit and to-be-modulated light corresponding to the second electro-optical conversion unit come from identical or different laser light source(s).

It's worth noting that the above only describes components or modules related to the present disclosure, but the present disclosure is not limited to this. The apparatus 1200 for real-time monitoring delay skew of a sub-signal of an optical transmitter in the embodiments of the present disclosure may further include other components or modules. For detailed contents of these components or modules, relevant technologies can be referred to.

For the sake of simplicity, FIG. 12 only exemplarily shows a connection relationship or signal direction between components or modules, however persons skilled in the art should know that various relevant technologies such as bus connection may be used. The above components or modules may be implemented by a hardware facility such as a processor, a memory, etc. The embodiments of the present disclosure have no limitation to this.

Each of the above embodiments is only illustrative for the embodiments of the present disclosure, but the present disclosure is not limited to this, appropriate modifications may be further made based on the above each embodiment. For example, each of the above embodiments may be used individually, or one or more of the above embodiments may be combined.

As may be known from the above embodiments, in the present disclosure, delay skew is determined using a signal output by an electro-optical conversion unit of an optical transmitter, real-time monitoring of the delay skew is implemented, and there is no need for the optical transmitter to transmit a special signal; moreover, in the present disclosure, sub-signal delay skew monitoring of the optical transmitter may be implemented by using a low-bandwidth electrical device, which avoids use of a high-speed equipment, and may be flexibly implemented via an integrated or non-integrated mode; in addition, application scenarios of the present disclosure are rich, and are suitable for sub-signal delay skew monitoring in a variety of optical transmitters.

### Embodiments of a Third Aspect

The embodiments of the present disclosure provide an electronic device, including the apparatus 1200 for real-time monitoring delay skew of a sub-signal of an optical transmitter as described in the embodiments of the second aspect, whose contents are incorporated here. The electronic device may be, for example, a computer, server, a workstation, a laptop computer, a smartphone, etc.; however, the embodiments of the present disclosure are not limited to this.

FIG. 13 is a schematic diagram of an electronic device in the embodiments of the present disclosure. As shown in FIG. 13, an electronic device 1300 may include: a processor (such as a central processing unit (CPU)) 1310 and a memory 1320; the memory 1320 is coupled to the central processing unit 1310. The memory 1320 may store various data; moreover, further stores a program 1321 for information processing, and executes the program 1321 under the control of the processor 1310.

In some embodiments, the function of the apparatus 1200 for real-time monitoring delay skew of a sub-signal of an optical transmitter is integrated into the processor 1310 for implementation. The processor 1310 is configured to implement the method for real-time monitoring delay skew of a sub-signal of an optical transmitter as described in the embodiments of the first aspect.

In some embodiments, the apparatus 1200 for real-time monitoring delay skew of a sub-signal of an optical transmitter is configured separately from the processor 1310, for example the apparatus 1200 for real-time monitoring delay skew of a sub-signal of an optical transmitter is configured as a chip connected to the processor 1310, a function of the apparatus 1200 for real-time monitoring delay skew of a sub-signal of an optical transmitter is implemented through the control of the processor 1310.

For example, the processor 1310 is configured to perform the following control:

input a first input signal to a first electro-optical conversion unit to enable the first electro-optical conversion unit to modulate to-be-modulated light according to the first input signal, to obtain a first output signal; input a second input signal to a second electro-optical conversion unit to enable the second electro-optical conversion unit to modulate to-be-modulated light according to the second input signal, to obtain a second output signal, wherein the second input signal is a differential signal of the first input signal; perform correlation operation processing on the first output signal and the second output signal to obtain correlation of the first input signal and the second input signal; and determine delay skew between an output signal of the first electro-optical conversion unit and an output signal of the second electro-optical conversion unit according to the correlation and a pre-set corresponding relation between correlation and the delay skew.

In addition, as shown in FIG. 13, the electronic device 1300 may further include: an input/output (I/O) device 1330 and a display 1340, etc., wherein the functions of said components are similar to relevant arts, and are not repeated here. It's worth noting that the electronic device 1300 does not have to include all the components shown in FIG. 13. Moreover, the electronic device 1300 may also include components not shown in FIG. 13, relevant technologies may be referred to.

The embodiments of the present disclosure further provide a computer readable program, wherein when an electronic device executes the program, the program enables a computer to execute the method for real-time monitoring delay skew of a sub-signal of an optical transmitter as described in the embodiments of the first aspect, in the electronic device.

The embodiments of the present disclosure further provide a storage medium in which a computer readable program is stored, wherein the computer readable program enables a computer to execute the method for real-time monitoring delay skew of a sub-signal of an optical transmitter as described in the embodiments of the first aspect, in the electronic device.

The apparatus and method in the present disclosure may be realized by hardware, or may be realized by combining hardware with software. The present disclosure relates to such a computer readable program, when the program is executed by a logic component, the computer readable program enables the logic component to realize the apparatus described in the above text or a constituent component, or enables the logic component to realize various methods or steps described in the above text. The present disclosure further relates to a storage medium storing the program, such as a hard disk, a magnetic disk, an optical disk, a DVD, a flash memory and the like.

By combining with the method/apparatus described in the embodiments of the present disclosure, it may be directly reflected as hardware, a software executed by a processor, or a combination of the two. For example, one or more in the functional block diagram or one or more combinations in the functional block diagram as shown in the drawings may correspond to software modules of a computer program flow, and may also correspond to hardware modules. These software modules may respectively correspond to the steps as shown in the drawings. These hardware modules may be realized by solidifying these software modules e.g. using a field-programmable gate array (FPGA).

A software module may be located in a RAM memory, a flash memory, a ROM memory, an EPROM memory, an EEPROM memory, a register, a hard disk, a mobile magnetic disk, a CD-ROM or a storage medium in any other form as known in this field. A storage medium may be coupled to a processor, thereby enabling the processor to read information from the storage medium, and to write the information into the storage medium; or the storage medium may be a constituent part of the processor. The processor and the storage medium may be located in an ASIC. The software module may be stored in a memory of a mobile terminal, and may also be stored in a memory card of the mobile terminal. For example, if a device (such as the mobile terminal) adopts a MEGA-SIM card with a larger capacity or a flash memory apparatus with a large capacity, the software module may be stored in the MEGA-SIM card or the flash memory apparatus with a large capacity.

One or more in the functional block diagram or one or more combinations in the functional block diagram as described in the drawings may be implemented as a general-purpose processor for performing the functions described in the present disclosure, a digital signal processor (DSP), an application-specific integrated circuit (ASIC), a field-programmable gate array (FPGA) or other programmable logic device, discrete gate or transistor logic device, discrete hardware components or any combination thereof. One or more in the functional block diagram or one or more combinations in the functional block diagram as described in the drawings may further be implemented as a combination of computer equipment, such as a combination of a DSP and a microprocessor, a plurality of microprocessors, one or more microprocessors combined and communicating with the DSP or any other such configuration.

The present disclosure is described by combining with the specific implementations, however persons skilled in the art should clearly know that these descriptions are exemplary and do not limit the protection scope of the present disclosure. Persons skilled in the art can make various variations and modifications to the present disclosure based on the principle of the present disclosure, these variations and modifications are also within the scope of the present disclosure.

As for the implementations including the above embodiments, the following supplements are further disclosed:

Supplement 1. A method for real-time monitoring delay skew of a sub-signal of an optical transmitter, the method including: inputting a first input signal to a first electro-optical conversion unit, to enable the first electro-optical conversion unit to modulate to-be-modulated light according to the first input signal and to obtain a first output signal; inputting a second input signal to a second electro-optical conversion unit, to enable the second electro-optical conversion unit to modulate to-be-modulated light according to the second input signal and to obtain a second output signal, wherein the second input signal is a differential signal of the first input signal; performing correlation operation processing on the first output signal and the second output signal to obtain correlation of the first input signal and the second input signal; and determining delay skew between an output signal of the first electro-optical conversion unit and an output signal of the second electro-optical conversion unit according to the correlation and a pre-set corresponding relation between correlation and the delay skew.

Supplement 2. The method according to Supplement 1, wherein the first electro-optical conversion unit is a transmitter, or a partial modulation unit of the transmitter.

Supplement 3. The method according to Supplement 1, wherein the second electro-optical conversion unit outputs a finite number of states.

Supplement 4. The method according to Supplement 1, wherein the differential signal of the first input signal includes: a difference of the first input signal at two different moments; or a symbol sequence of the difference of the first input signal at two different moments; or a product of the symbol sequence of the difference of the first input signal at two different moments and a finite number of a random amplitude sequence; or a product of the symbol sequence of the difference of the first input signal at two different moments and an infinite number of a random amplitude sequence.

Supplement 5. The method according to Supplement 1, wherein performing correlation operation processing on the first output signal and the second output signal to obtain correlation of the first input signal and the second input signal includes: determining a product signal of the first output signal and the second output signal via a photoelectric method or an optical method; and performing an electrical average operation on the product signal to obtain correlation of the first input signal and the second input signal.

Supplement 6. The method according to Supplement 1, wherein the first input signal is A[n], the second input signal is a differential signal of the first input signals A[n+k₁] and A[n+k₂] at two different moments, k₁ and k₂ are integers and k₁≠k₂; the corresponding relation between the correlation and the delay skew includes:

$$S = k * ( τ + ( {k}_{1 +} {k}_{2} ) T / 2 )$$

where, S is the correlation, T is delay skew between the first electro-optical conversion unit and the second electro-optical conversion unit, T is a unit time length corresponding to the time sequence number n, k₁ and k₂ are integers and k₁≠k₂, and k is a known quantity related to k₁ and k₂.

Supplement 7. The method according to Supplement 1, wherein at a pre-set moment, the second input signal is input to the second electro-optical conversion unit; and at a moment other than the pre-set moment, a signal unrelated to the first input signal or a 0 signal is input to the second electro-optical conversion unit.

Supplement 8. The method according to Supplement 1, wherein the method further includes: determining, respectively according to correlation of the output signals of a plurality of first electro-optical conversion units and the output signal of the second electro-optical conversion unit and a corresponding relation between correlation corresponding to the correlation and delay skew, delay skew between output signals of the plurality of the first electro-optical conversion units and an output signal of the second electro-optical conversion unit; and the apparatus further includes a delay calibration unit, configured to calibrate delay between the plurality of first electro-optical conversion units based on each of the delay skew.

Supplement 9. The method according to Supplement 1, wherein to-be-modulated light corresponding to the first electro-optical conversion unit and to-be-modulated light corresponding to the second electro-optical conversion unit come from identical or different laser light source(s).

Supplement 10. An electronic device, including a memory and a processor, the memory storing a computer program, and the processor being configured to execute the computer program to implement a method for real-time monitoring delay skew of a sub-signal of an optical transmitter according to any one of Supplements 1 to 9.

Supplement 11. A storage medium storing a computer readable program, wherein the computer readable program enables a computer to execute a method for real-time monitoring delay skew of a sub-signal of an optical transmitter according to any one of Supplements 1 to 9, in an electronic device.

1. An apparatus to real-time monitor a delay skew of a sub-signal of an optical transmitter, comprising:
a processor coupled to a memory and configured to,
input a first input signal to a first electro-optical conversion unit, to enable the first electro-optical conversion unit to modulate to-be-modulated light according to the first input signal and to obtain a first output signal;
to input a second input signal to a second electro-optical conversion unit, to enable the second electro-optical conversion unit to modulate to-be-modulated light according to the second input signal and to obtain a second output signal, wherein the second input signal is a differential signal of the first input signal;
perform a correlation operation processing on the first output signal and the second output signal to obtain a correlation of the first input signal and the second input signal;
determine a delay skew between an output signal of the first electro-optical conversion unit and an output signal of the second electro-optical conversion unit, according to the correlation and a set corresponding relation between a correlation quantity and a time delay difference between the first electro-optical conversion unit and the second electro-optical conversion unit.

2. The apparatus according to claim 1, wherein the first electro-optical conversion unit is a transmitter, or a partial modulation unit of a transmitter.

3. The apparatus according to claim 1, wherein the second electro-optical conversion unit outputs a finite number of states.

4. The apparatus according to claim 1, wherein the differential signal of the first input signal comprises:
a difference of the first input signal at two different moments; or
a symbol sequence of a difference of the first input signal at two different moments; or
a product of a symbol sequence of a difference of the first input signal at two different moments and a finite number of a random amplitude sequence; or
a product of a symbol sequence of a difference of the first input signal at two different moments and an infinite number of a random amplitude sequence.

5. The apparatus according to claim 1, wherein to perform the correlation operation processing, the processor is further configured to:
determine a product signal of the first output signal and the second output signal via a photoelectric method or an optical method; and
perform an electrical average operation on the product signal to obtain the correlation of the first input signal and the second input signal.

6. The apparatus according to claim 1, wherein the first input signal is A[n], the second input signal is a differential signal of A[n+k1] and A[n+k2] at two different moments, k1 and k2 are integers and k1≠k2;
the set corresponding relation between the correlation quantity and the time delay difference includes:
$$S = k * ( τ + ( {k}_{1 +} {k}_{2} ) T / 2 )$$
where, S is the correlation quantity, τ is the time delay difference, T is a unit time length corresponding to a time sequence number n, k1 and k2 are integers and k1≠k2, and k is a known quantity related to k1 and k2.

7. The apparatus according to claim 1, wherein to input the second input signal, the processor is further configured to:
input, at a set moment, the second input signal to the second electro-optical conversion unit; and input, at a moment other than the set moment, a signal unrelated to the first input signal or a 0 signal to the second electro-optical conversion unit.

8. The apparatus according to claim 1, wherein the first electro-optical conversion unit includes a plurality of first electro-optical conversion units and to determine the delay skew, the processor is further configured to:
determine, respectively according to a correlation of output signals of the plurality of first electro-optical conversion units and the output signal of the second electro-optical conversion unit and the set corresponding relation between the correlation quantity and the time delay difference, the delay skew between each output signal of the output signals of each of the plurality of first electro-optical conversion units and the output signal of the second electro-optical conversion unit; and
calibrate a delay between the plurality of first electro-optical conversion units based on each respective delay skew determined.

9. The apparatus according to claim 1, wherein to-be-modulated light corresponding to the first electro-optical conversion unit and to-be-modulated light corresponding to the second electro-optical conversion unit come from identical or different laser light source(s).

10. A method of real-time monitoring a delay skew of a sub-signal of an optical transmitter, comprising:
inputting a first input signal to a first electro-optical conversion unit, to enable the first electro-optical conversion unit to modulate to-be-modulated light according to the first input signal and to obtain a first output signal;
inputting a second input signal to a second electro-optical conversion unit, to enable the second electro-optical conversion unit to modulate to-be-modulated light according to the second input signal and to obtain a second output signal, wherein the second input signal is a differential signal of the first input signal;
performing a correlation operation processing on the first output signal and the second output signal to obtain a correlation of the first input signal and the second input signal; and
determining a delay skew between an output signal of the first electro-optical conversion unit and an output signal of the second electro-optical conversion unit, according to the correlation and a set corresponding relation between a correlation quantity and a time delay difference between the first electro-optical conversion unit and the second electro-optical conversion unit.
